(19) United States
(12) Patent Application Publication
(10) Pub. No.: US 2023/0103018 A1
(43) Pub. Date: Mar. 30, 2023

(54) AN OFFSHORE JACK-UP INSTALLATION, ASSEMBLY AND METHOD

(71) Applicant: NOBLE DRILLING A/S, Kongens Lyngby (DK)

(72) Inventor: Jesper HOLCK, Hellerup (DK)

(73) Assignee: NOBLE DRILLING A/S, Kongens Lyngby (DK)

(21) Appl. No.: 17/793,802

(22) PCT Filed: Jan. 27, 2021
(86) PCT No.: PCT/DK2021/050026

§ 371 Date: Jul. 19, 2022

(30) Foreign Application Priority Data
Jan. 28, 2020 (DK) PA202000104

(51) Int. Cl. B01D 53/62; B01D 53/78; B01D 53/14; B01D 53/18; E21B 41/00

(52) U.S. Cl. CPC B01D 53/62; B01D 53/78; B01D 53/1475; B01D 53/18; B01D 53/1425; E21B 41/0064; B01D 2258/0283; B01D 2252/20484; B01D 2257/504; E02B 2017/0056

(57) ABSTRACT

An offshore installation including a powerplant adapted for powering an electricity distribution network of the offshore installation and an exhaust processing module . The exhaust processing module has an input connected to the powerplant for receiving exhaust gas comprising carbon dioxide from the powerplant, a carbon dioxide capture module arranged to separate carbon dioxide from the exhaust gas, and an output for outputting the separated carbon dioxide. The exhaust processing module is powered by the powerplant, and the outlet of the carbon dioxide capture module is connected to a storage facility for temporary storing the separated carbon dioxide.

The present invention relates to an offshore jack-up installation, assembly and method.

### BACKGROUND

Offshore oil and gas production platforms and drilling installations require energy to perform production and drilling operations. Under normal circumstances, fuel gas such as natural gas is obtained by the production platform is combusted in a gas-fired powerplant on the production platform. The combustion generator supplies power to meet the energy needs of the production platform and/or the drilling installation.

However, burning the fuel gas to power the production platform and/or the drilling installation causes carbon dioxide emissions as well as other undesirable gases. In some coastal areas, production platform and/or the drilling installation are required to reduce their carbon dioxide emissions during operation.

One proposal is to electrify the production platform and/or the drilling installations such that they do not burn fossil fuels during operation. However, electrification requires a plentiful supply of electricity generated from renewable sources in order to reduce the carbon dioxide emissions from the operation of the production platform and/or the drilling installation.

One another proposal is to pump carbon dioxide into an existing oil and gas reserve. This enhances the oil and gas recovery (EOR/EGR) from the oil and gas reserve. However, the oil and gas absorb the carbon dioxide and therefore the recovered oil and gas must be processed to remove the absorbed carbon dioxide. The removal of the absorbed carbon dioxide increases the energy required and increases the carbon dioxide emissions of the production platforms and/or the drilling installations.

Another proposal is discussed in “Offshore power generation with carbon capture and storage to decarbonise mainland electricity and offshore oil and gas installations: A technoeconomic analysis” S Roussanaly et al Applied Energy 233-234 (2019) p478-494. This proposal discusses a floating platform which receives natural gas from a pipeline and stores captured carbon dioxide below the seabed. A problem with this is that the floating platform must be positioned close to an existing natural gas pipeline or another suitable supply of processed fuel-gas. Furthermore, the floating platform must be specially designed to operate in harsh weather conditions. For example, the mooring ropes or the dynamic positioning system must be increased in size and capacity to maintain the position of the floating platform within allowable excursions for harsh weather. The floating rig may also be limited by the minimum water depth in which it can operate.

The proposal also discloses a fixed installation option whereby natural gas is extracted from a gas field and converted to electricity on the fixed installation. Carbon dioxide is then stored below the seabed. A problem with a fixed installation is that the installation and decommissioning of the fixed installation takes significant time and resources. This is problematic if the oil and gas field is marginal with a limited expected lifetime. This means that if the oil and gas field is depleted, the fixed installation cannot be easily moved to provide power to production platforms elsewhere.

Examples of the present invention aim to address the aforementioned problems.

According to an aspect of the present invention, there is an offshore jack-up installation comprising a hull; a plurality of moveable legs engageable with the seafloor, wherein the offshore installation is arranged to move the legs with respect to the hull to position the hull out of the water when the legs engage the seafloor; an exhaust processing module arranged to receive exhaust gas comprising carbon dioxide, the exhaust module arranged to process carbon dioxide in the exhaust gas and to output processed carbon dioxide to at least one other offshore installation for storage in carbon dioxide storage pocket in the seabed.

Optionally, the offshore jack-up installation comprises a powerplant and the exhaust of the powerplant is outputted from the powerplant to the exhaust processing module.

Optionally, the offshore jack-up installation comprises at least one output power port arranged to output power to the at least one other offshore installation or to an onshore electricity distribution network.

Optionally, the offshore jack-up installation comprises at least one input fuel gas duct for receiving fuel gas from the at least one other offshore installation.

Optionally, the exhaust processing module is in fluid communication with another powerplant mounted on the at least one other offshore installation and the exhaust of the other powerplant is outputted to the exhaust processing module.

Optionally, the powerplant on the offshore jack-up installation or the powerplant mounted on the at least one other offshore installation powers the exhaust processing module.

Optionally, the exhaust processing module comprises a carbon dioxide capture module arranged to separate carbon dioxide from the exhaust gas.

Optionally, the carbon dioxide capture module is a scrubber mounted in a flue gas exhaust duct.

Optionally, the exhaust processing module comprises a carbon dioxide processing module arranged to compress, cool, dewater, liquify and/or store the separated carbon dioxide.

Optionally, the offshore jack-up installation comprises a steam generator.

Optionally, the generated steam is used for heating the carbon dioxide in the exhaust processing module.

Optionally, the steam generator is in fluid communication with another offshore installation and the generated steam is used for heating offshore oil and gas production equipment.

Optionally, the steam generator is in fluid communication with a steam-methane reforming module.

Optionally, the steam-methane reforming module is in fluid communication with the exhaust processing module.

Optionally, the steam-methane reforming module is in fluid communication with a pipeline for pumping generated hydrogen directly to shore or via an H₂ tanker vessel.

Optionally, the offshore jack-up installation comprises an air separation module configured to output concentrated oxygen to powerplant on the offshore jack-up installation or the powerplant mounted on the at least one other offshore installation.

Optionally, the at least one other offshore installation is one or more of the following: a production platform, a wellhead platform, a jack-up drilling rig, a semi-submersible rig or a drilling vessel.

Optionally, the at least one other offshore installation stores the outputted processed carbon dioxide in a carbon dioxide storage pocket remote from submarine oil and gas reserves.

Optionally, the carbon dioxide is pumped via a subsea pipe to a submerged wellhead.

Optionally, the carbon dioxide storage pocket in the seabed is a saline aquifer, an active oil and gas field, or a depleted oil and gas field.

Optionally, the exhaust processing module comprises an auxiliary input port arrange to receive carbon dioxide from a vessel or from a subsea pipeline.

Optionally, the offshore jack-up installation comprises accommodation for the offshore jack-up installation operations and/or for the operations of at least one other offshore installation.

In another aspect of the invention there is an offshore installation assembly comprising a production platform in fluid connection with a submarine oil and gas reserve and arranged to generate fuel gas and the production platform is in fluid connection with a carbon dioxide storage pocket in the seabed; and an offshore jack-up installation comprising a hull; a plurality of moveable legs engageable with the seafloor, wherein the offshore installation is arranged to move the legs with respect to the hull to position the hull out of the water when the legs engage the seafloor and positioned adjacent to a production platform; a powerplant for burning fuel gas received from the production platform and arranged to generate power; an exhaust processing module arranged to receive exhaust gas comprising carbon dioxide in fluid communication with an exhaust port of the powerplant, the exhaust processing module arranged to process carbon dioxide from the exhaust of the powerplant; and the exhaust processing module is arranged to output processed carbon dioxide to the production platform for storage in the carbon dioxide storage pocket.

In another aspect of the invention, there is provided a method of operating an offshore jack-up installation, the offshore jack-up installation having an exhaust processing module arranged to receive exhaust gas comprising carbon dioxide, the method comprising moving an offshore jack-up installation adjacent to a production platform; connecting the exhaust processing module to the production platform; connecting the production platform to a carbon dioxide storage pocket in the seabed; processing carbon dioxide in the exhaust gas; outputting processed carbon dioxide to the production platform; and storing the processed carbon dioxide in the carbon dioxide storage pocket.

In yet another aspect of the invention, there is an offshore jack-up installation comprising a hull; a plurality of moveable legs engageable with the seafloor, wherein the offshore installation is arranged to move the legs with respect to the hull to position the hull out of the water when the legs engage the seafloor; and an exhaust processing module arranged to receive exhaust gas comprising carbon dioxide, the exhaust module arranged to process carbon dioxide in the exhaust gas and to output processed carbon dioxide for storage.

Various other aspects and further embodiments are also described in the following detailed description and in the attached claims with reference to the accompanying drawings, in which:

### FIGURES & DESCRIPTION

FIG. 1 shows a side view of an offshore jack-up installation according to an example;

FIGS. 2 and 3 respectively show a schematic diagram and a close-up schematic diagram of an offshore jack-up installation according to an example;

FIGS. 4 and 5 respectively show a schematic diagram and a close-up schematic diagram of an offshore jack-up installation according to another example;

FIGS. 6 and 7 respectively show a schematic diagram and a close-up schematic diagram of an offshore jack-up installation according to another example;

FIGS. 8 and 9 respectively show a schematic diagram and a close-up schematic diagram of an offshore jack-up installation according to another example;

FIGS. 10 and 11 respectively show a schematic diagram and a close-up schematic diagram of an offshore jack-up installation according to another example;

FIGS. 12 and 13 respectively show a schematic diagram and a close-up schematic diagram of an offshore jack-up installation according to another example;

FIGS. 14 and 15 respectively show a schematic diagram and a close-up schematic diagram of an offshore jack-up installation according to another example;

FIG. 16 shows a close-up schematic diagram of an offshore jack-up installation according to another example;

FIG. 17 shows a close-up schematic diagram of an offshore jack-up installation according to another example;

FIG. 18 shows a close-up schematic diagram of an offshore jack-up installation according to another example;

FIG. 19 shows a flow diagram of the method of operation of an offshore jack-up installation according to an example; and

FIG. 20 shows a close-up schematic diagram of an offshore jack-up installation according to another example.

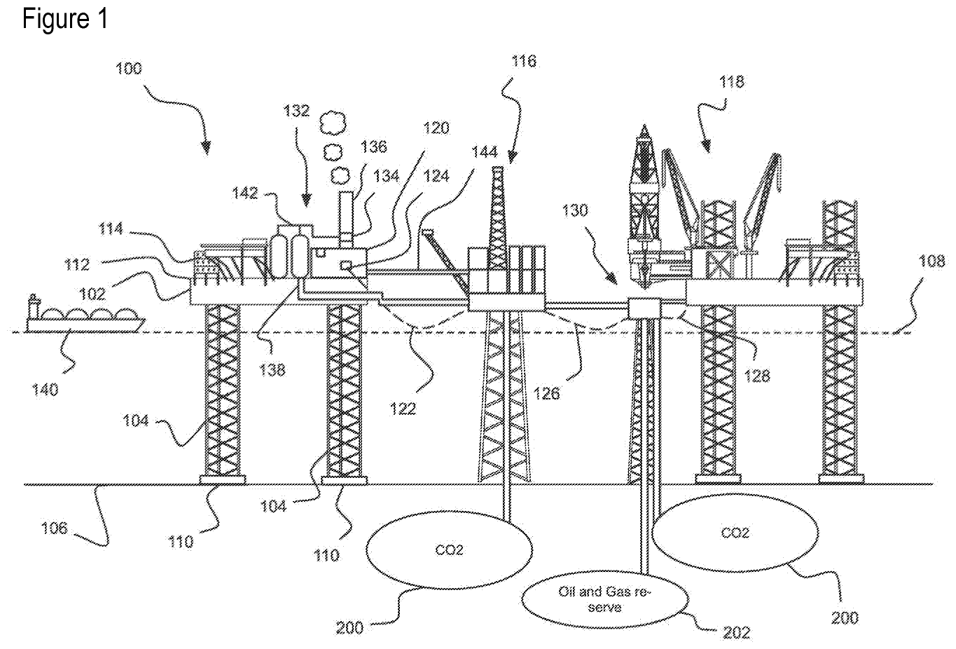

FIG. 1 shows a side view of an offshore jack-up installation 100 according to an example. In some examples, the offshore jack-up installation 100 is a retrofitted jack-up former drilling rig.

The offshore jack-up installation 100 is floatable and comprises a hull 102. The hull 102 comprises a plurality of legs 104 which extend through the hull 102 and engage the seabed 106. The legs 104 comprise spudcans 110 which are arranged to engage the seabed 106. The offshore jack-up installation 100 is shown in an operational position with the hull 102 being positioned above the surface of the water 108. The offshore jack-up installation 100 is moveable between different locations.

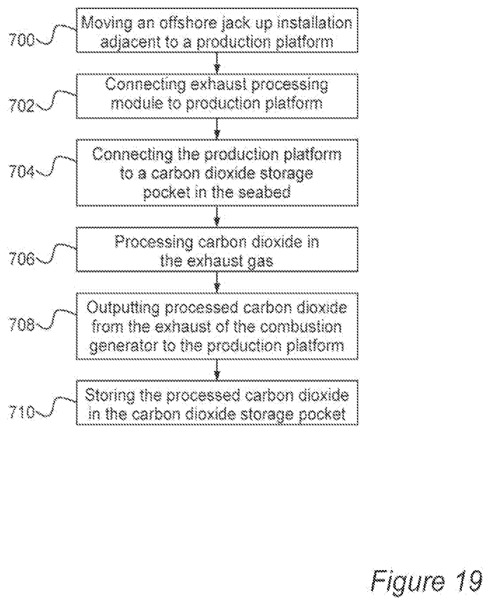

When the offshore jack-up installation 100 moves between locations, the plurality of the legs 104 are retracted and the offshore jack-up installation 100 is sailed to the new location. The offshore jack-up installation 100 can be towed with one or more tugboats (not shown). In some examples, the offshore jack-up installation 100 is moved adjacent to one or more offshore installations or rigs 116, 118, 130 as shown in step 700 of FIG. 19. FIG. 19 shows a flow diagram of the method of operation of an offshore jack-up installation 100 according to an example.

The offshore jack-up installation 100 comprises a main deck 112, an accommodation structure 114 for housing personnel. The accommodation structure 114 can be used for housing personnel working on the offshore jack-up installation 100 or one or more adjacent offshore installations 116, 118, 130. Advantageously, this means that additional offshore installations providing accommodation for the production platform 116 are not needed. By providing the accommodation structure 114 on the offshore jack-up installation 100, the carbon dioxide emissions generated from providing the hotel load required for the accommodation structure 114 can be captured by an exhaust processing module 132 thereby reducing potentially further emissions vented to the atmosphere. The exhaust processing module 132 will be discussed in further detail below.

The main deck 112 of the offshore jack-up installation 100 may be used for storing equipment used in operations of adjacent offshore installations 116, 118, 130. For example, the main deck 112 can be used to store equipment used in production operations on a production platform 116 or drilling operations on an offshore drilling rig 118. In some examples, there is a bridge (not shown) extending between the offshore jack-up installation 100 and the adjacent offshore installations 116, 118, 130. The bridge can comprise a walkway, electrical connections, flue gas ducting, fuel gas pipes and any other suitable cable connection or pipe between the offshore jack-up installation 100 and the adjacent offshore installations 116, 118, 130.

The production operations on a production platform 116 or drilling operations on an offshore drilling rig 118 are known and will not be discussed in any further detail hereinafter.

The offshore jack-up installation 100 has a powerplant 120. In some examples, the powerplant 120 comprises at least one combustion generator for generating electricity. In some examples, the combustion generator is a gas turbine generator (not shown) or a diesel generator. The gas turbine generator is arranged to burn natural gas or any other fuel gas such as methane, hydrogen etc. and generate electricity. In some examples, there is a plurality of gas turbine generators. For example, there can be two, three, four, five, six, seven, or eight or any number of gas turbine generators.

In some examples, the offshore jack-up installation 100 optionally comprises a fuel gas storage tank (not shown) for storing fuel gas to be burnt in the powerplant 120.

In some examples, powerplant 120 is arranged to generate an electrical supply for the offshore jack-up installation 100 and other adjacent offshore installations 116, 118, 130 such as the production platform 116 and the offshore drilling rig 118. The offshore rig performs power consuming operations, and these are powered from an electricity distribution network (microgrid). The electricity distribution network normally operates as an autonomically network in a so-called “island mode”. According to the invention, the powerplant 120 powers the electricity distribution network, and the powerplant 120 is often based on several diesel generators. The offshore drilling rig 118 can optionally be a semisubmersible rig (not shown) positioned by mooring and/or anchor system and/or a dynamic positioning system. In some examples, the powerplant 120 has a generation capacity of several hundreds of Megawatts of combined electrical and thermal power. A significant fraction of the total power by the powerplant 120 may be for generating steam for both electrical power generation (e.g. by exhaust heat recovery) and for heating purposes. The CC absorbent-regenerative system, as discussed below, for dissolving the CO2 out of the absorbents may require considerable heating and may be in excess of what is achievable by exhaust heat recovery. In some other examples, the powerplant 120 has a generation capacity of between 400 MW to 800 MW. In other examples the powerplant 120 as a generation capacity of 150 MW, 200 MW, 300 MW, 400 MW, 500 MW, 600 MW, 700 MW, 800 MW, 900 MW, 1000 MW. In other examples, the powerplant 120 can have any suitable capacity such that it can generate electricity or generate electricity and heating for both the offshore jack-up installation 100 (e.g. for powering the on-board carbon capture and processing systems, as discussed below) and other adjacent offshore installations 116, 118, 130. The exhaust processing module 132 discussed below which is configured to capture carbon from exhaust may require between 20% to 30% of the power generated by the powerplant 120.

In this way, the offshore jack-up installation 100 comprises at least one output power port 124 arranged to output power to the at least one other offshore installation 116, 118, 130. An electrical cable 122 is connected between the output power port 124 and the production platform 116. This means that the powerplant 120 can generate electricity and provide power to the production platform 116. Additional cables 126, 128 can optionally be provided to provide power to other adjacent installations such as a wellhead platform 130 and the offshore drilling rig 118. The additional cables 126, 128 can be daisy-chained between the different adjacent offshore installations 116, 118, 130. Alternatively, the additional cables 126, 128 can each extend from the offshore jack-up installation 100 in a hub-spoke arrangement (not shown).

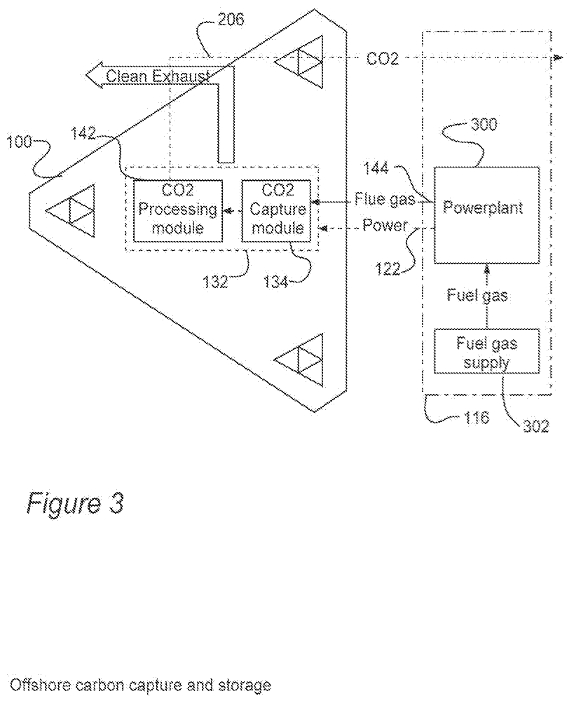

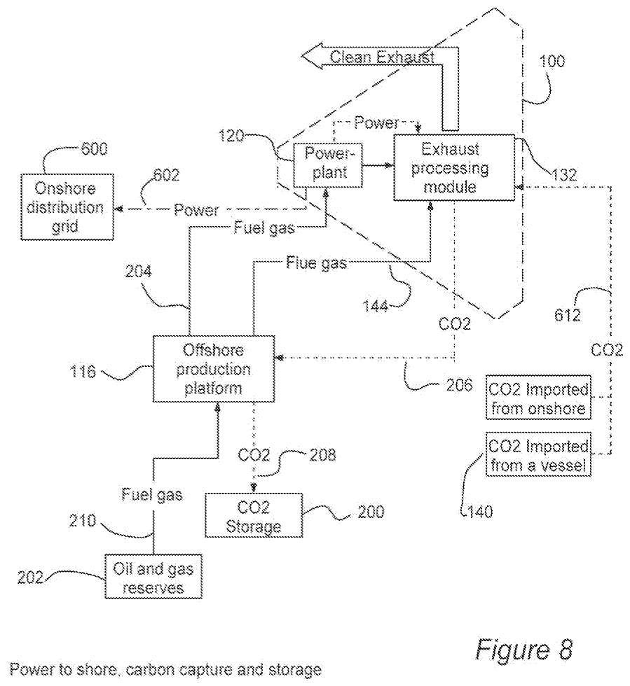

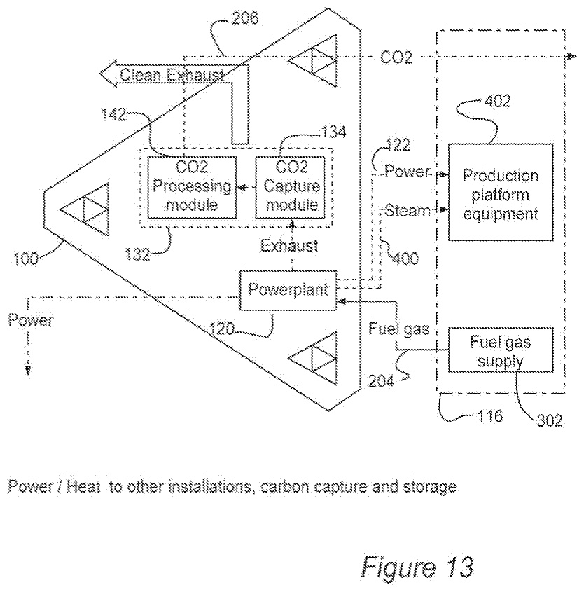

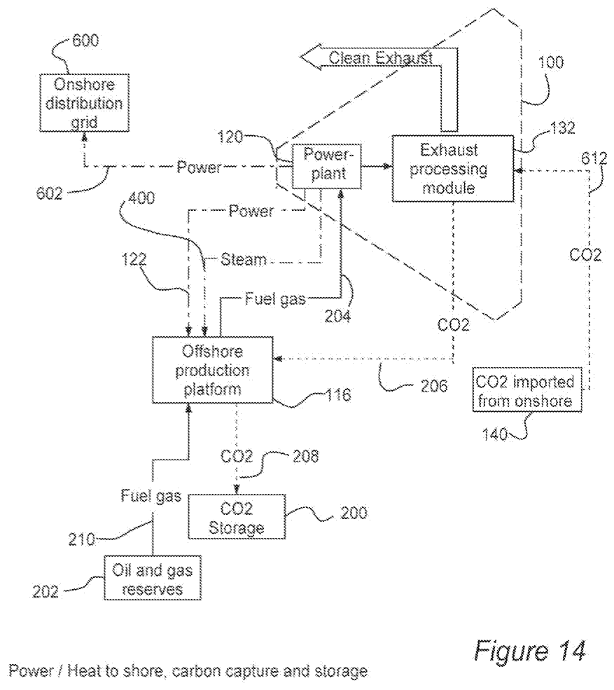

The production platform 116 as shown in FIG. 1 comprises a large production platform powerplant 300 (as shown in FIG. 3) which is typically 50-100 MW or more. In some examples, the production platform powerplant 300 may be entirely shut-down or decommissioned. In this example, all production facilities of the production platform 116 are powered and heated (by steam) from the powerplant 120 of the offshore jack-up installation 100 (this is discussed in more detail with respect to FIGS. 13, 14 15 and 16). In some examples, excess electrical power generated by the powerplant 120 can be sent to shore. Transmission of excess power to shore will be discussed in further detail below with respect to FIGS. 8, 9, 13, 14, 15 and 16.

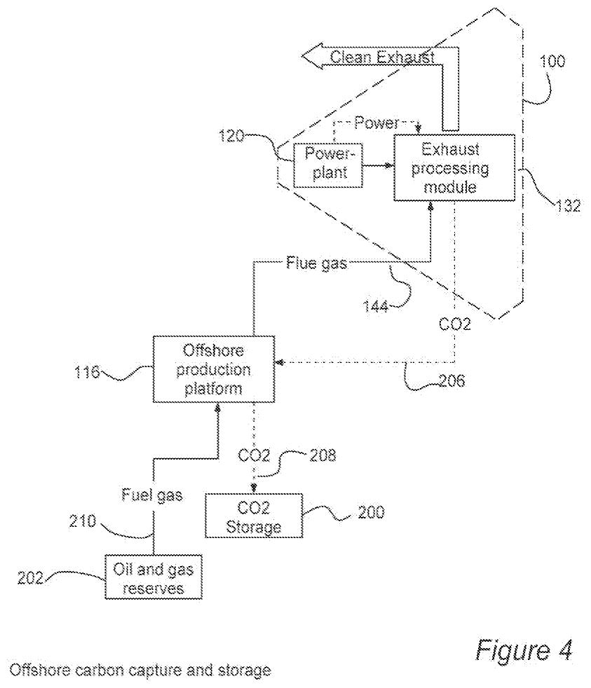

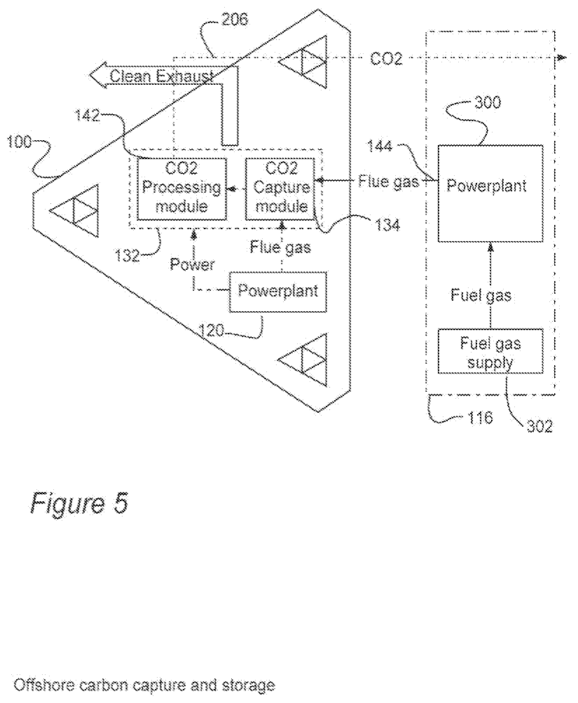

Alternatively, the production platform powerplant 300 is maintained in an operational status. In this case, all the exhaust ducting (not shown) of the production platform powerplant 300 is rerouted to the offshore jack-up installation 100 for exhaust processing. In this case, the powerplant 120 on the offshore jack-up installation 100 is not be required or alternatively the powerplant 120 runs in parallel. In some examples where the offshore jack-up installation 100 comprises the powerplant 120, the powerplant 120 may be smaller than the production platform powerplant 300 and arranged to only power and heat the carbon capture and processing systems. This will be discussed in further detail below with respect to FIGS. 4 and 5.

The offshore jack-up installation 100 comprises an exhaust processing module 132.

The exhaust processing module 132 is configured to generate a clean exhaust with no or significantly reduced carbon dioxide content. The exhaust processing module 132 comprises a carbon dioxide capture module 134 and a carbon dioxide processing module 142 as shown in FIG. 3. The exhaust processing module 132 in other examples can comprise additional processing modules for treating the exhaust gas and/or the carbon dioxide.

As will be understood from other examples discussed below, the carbon dioxide capture module 134 is optional and a flow of carbon dioxide gas is pumped directly to the carbon dioxide processing module 142. Other examples which do not use a carbon dioxide capture module 134 will be described below.

In some examples, the carbon dioxide capture module 134 is a scrubber mounted in series with a flue-gas exhaust system 136. Carbon dioxide scrubbing is a well-known technology used for removal of carbon dioxide from the exhaust of power plants fired by fossil fuels. The primary technology applied involves the use of various amines, e.g. monoethanolamine. Cold solutions of these organic compounds bind carbon dioxide, and the binding is reversed at higher temperatures. This means that the carbon dioxide capture module 134 is integral with the flue-gas exhaust system 136. Thereby the exhaust gas flowing through the flue-gas exhaust system 136 also flows through the carbon dioxide capture module 134. The flue-gas exhaust system 136 is in fluid communication with an exhaust outlet of the powerplant 120. Alternatively or additionally the flue-gas exhaust system 136 and the carbon capture module 134 can be in fluid communication with the production platform powerplant 300. In this case, exhaust outlets from either the powerplant 120 on the offshore jack-up installation 100 or from the production platform powerplant 300 are connected to the flue -gas exhaust system 136 and the exhaust processing module 132. In this way, exhaust flue gases from either the powerplant 120 on the offshore jack-up installation 100 or from the production platform powerplant 300 pass through the carbon capture module 134. The flue 136 is connected to the production platform powerplant 300 via large heavy ducting 144 across the connecting bridge between the offshore jack-up installation 100 and the production platform 116.

The carbon dioxide capture module 134 is arranged to receive exhaust gas comprising carbon dioxide from the powerplant 120. The carbon dioxide capture module 134 carries out post-combustion carbon capture. In some examples, the exhaust gas comprising carbon dioxide is received from the production platform powerplant 300. Accordingly, the exhaust is the emissions resulting from burning the fuel gas during combustion in the gas turbine generator.

The carbon dioxide processing module 142 receives the separated carbon dioxide from the carbon dioxide capture module 134. The carbon dioxide processing module 142 processes the captured carbon dioxide so that it is suitable for storage in a carbon dioxide storage pocket 200 in the seabed 106.

In order to make the captured carbon dioxide suitable for undersea storage, the carbon dioxide processing module 142 is configured to carry out one or more processes on the captured carbon dioxide. The carbon dioxide processing module 142 is arranged to carry out one or more of the following on the carbon dioxide: compression, cooling, de-watering, liquefaction and temporary storage. Carbon dioxide in liquid state can only exist at a pressure above 5.1 atm, in the temperature range between 31.1° C. (temperature of critical point) and −56.6° C. (temperature of triple point). The carbon dioxide processing module 142 can serve as an import/export hub for carbon dioxide on and off the offshore jack-up installation 100. The carbon dioxide processing module 142 may also receive (or export) carbon dioxide from/to tanker vessels and/or seabed pipelines from/to shore facilities. Thereafter, the carbon dioxide processing module 142 cryogenically pumps the carbon dioxide over to the production platform 116 and/or the wellhead platform 130 for well injection.

The exhaust processing module 132 is electrically connected to the powerplant 120. Accordingly, the powerplant 120 powers the exhaust processing module 132. In some examples, depending on the carbon dioxide load the exhaust processing module 132 uses, an estimated 20-30% of the generated heat and power load. The exhaust processing module power load 132 is “parasitic” for powering the carbon capturing and -processing systems from capture to injection into the well. The powerplant 120 is arranged to generate more power than the electrical load of the exhaust processing module 132 during operation. Alternatively, the production platform powerplant 300 can power the exhaust processing module 132 if the production platform powerplant 300 generates excess power.

In some examples, the carbon dioxide capture module 134 performs reactive absorption of carbon dioxide using monoethanolamine as solvent for the exhaust in the flue 136. The exhaust gas is cooled to e.g. between 35° C. to 65° C. and the cooled exhaust gas is sent to a packed bed absorber comprising the monoethanolamine solvent.

The monoethanolamine solvent comprising the absorbed carbon dioxide is passed to a regenerator (not shown) requiring considerable re-heating where carbon dioxide is released. The carbon dioxide is then compressed and dehydrated. After compression to 80 bar, the carbon dioxide is cooled with cooling water and then pumped to 110 bars. At this point, the carbon dioxide is suitable for undersea storage. The storage process will be discussed in further detail below.

In some examples, the exhaust processing module 132 can comprise any suitable process for removing carbon dioxide from the exhaust of the powerplant 120. Whilst a process using a monoethanolamine solvent is described, any other suitable solvent can be used. Other such methods of removing carbon dioxide will be discussed hereinafter.

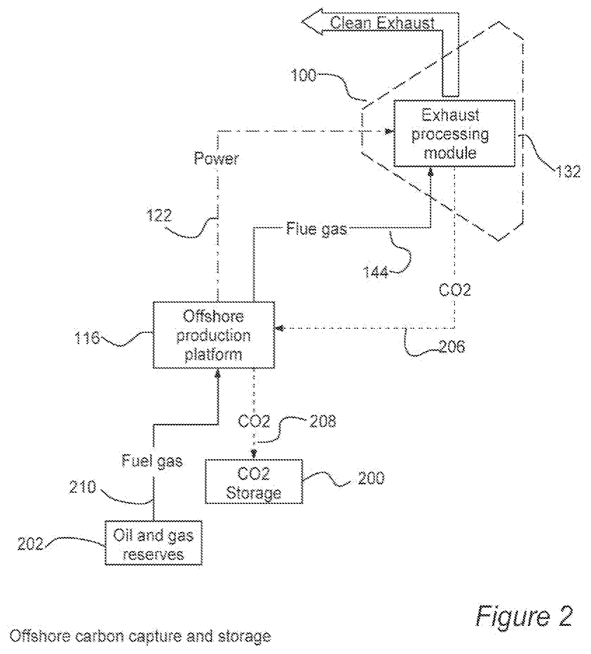

One example will now be discussed in reference to FIGS. 2 and 3. FIGS. 2 and 3 respectively show a schematic representation of the offshore jack-up installation 100 and a close-up of the offshore jack-up installation 100. FIGS. 2 and 3 show an example whereby the offshore jack-up installation 100 is adjacent to the production platform 116 and the production platform powerplant 300 provides power and optionally heat/steam to the exhaust processing module 132.

The production platform powerplant 300 receives fuel gas from a fuel gas storage tank 302. The production platform powerplant 300 then burns the fuel gas in on or more gas turbines and generates electricity and steam heating for the oil and gas separation processes. The offshore jack-up installation 100 is electrically connected to the production platform 116 with electric cable 122. In this way, the production platform 116 can supply at least some or all of the electrical energy that the offshore jack-up installation 100 needs to operate.

The production platform 116 sends flue gas to the exhaust processing module 132 on the offshore jack-up installation 100 via the ducting 144.

As shown in FIG. 2, the production platform 116 is connected to an oil and gas reserve 202 via a riser 210 and is arranged to extract fuel gas e.g. natural gas from the oil and gas reserve 202. Extraction of the oil and gas using the production platform 116 is known and will not be discussed in any further detail.

The production platform powerplant 300 is in fluid connection with the exhaust processing module 132 as discussed in reference to FIG. 1. Accordingly, the exhaust from the production platform powerplant 300 is sent to the exhaust processing module 132. The carbon dioxide capture module 134 extracts carbon dioxide from the exhaust as shown in step 706 of FIG. 19 and as previously discussed.

Once the carbon dioxide has been separated from the exhaust gas, the remaining exhaust gas can be vented into the atmosphere or further processed. For example, the exhaust processing module 132 may comprise one or more further modules for processing the exhaust gas. For example, the remaining exhaust gas can be passed through a scrubber (not shown) for removing SOx or NOx emissions. In some examples, the exhaust gas from the powerplant 120 or the production platform powerplant 300 can be passed through the SOx or NOx scrubber before the exhaust gas is processed by the exhaust processing module 132. The SOx and NOx scrubbers are known and will not be discussed in any further detail.

The offshore jack-up installation 100 is further connected to the production platform 116 with a carbon dioxide pipe 206 as shown in FIGS. 2 and 3. The output port 138 from the carbon dioxide processing module 142 is connected to the production platform 116 via the carbon dioxide pipe 206 as shown in step 702 in FIG. 19. The carbon dioxide pipe 206 is arranged to receive a gaseous or liquid form of carbon dioxide from at least one output port 138 in fluid communication with the exhaust processing module 132. The carbon dioxide pipe 206 can be constructed from a corrosive resistant material such as stainless steel to withstand the corrosive properties of the carbon dioxide. In this way, the production platform 116 can receive the separated carbon dioxide for subsequent submarine storage as shown in step 708 of FIG. 19.

The production platform 116 is in fluid connection with a carbon dioxide storage pocket 200 in the seabed 106 as shown in step 704 in FIG. 19. The carbon dioxide storage pocket 200 is stable and capable of retaining the carbon dioxide pumped into it. The carbon dioxide is then stored in the carbon dioxide storage pocket 200 as shown in step 710 of FIG. 19. The production platform 116 is connected to the carbon dioxide storage pocket 200 via a carbon dioxide riser 208. Similar to the carbon dioxide pipe 206, the carbon dioxide riser 208 can be constructed from a corrosive resistant material such as stainless steel to withstand the corrosive properties of the carbon dioxide. The carbon dioxide storage pocket 200 comprises a well cap to ensure that the carbon dioxide is retained within the carbon dioxide storage pocket 200. The well cap comprises a Christmas tree (not shown) or other suitable valve mechanism for allowing carbon dioxide to be pumped into carbon dioxide storage pocket 200 and retaining the carbon dioxide therein.

In some examples, the carbon dioxide storage pocket 200 is a saline aquifer, an active oil and gas field, and/or a depleted oil and gas field. Carbon dioxide may be permanently stored in the carbon dioxide storage pocket 200. In this way, the carbon dioxide is retained and prevented from escaping into the atmosphere.

Advantageously, this means that the offshore jack-up installation 100 can generate all the electricity for an offshore installation and at the same time the carbon dioxide generated from the electricity generation can be captured and stored. By using an offshore jack-up installation 100, the time to move and install the offshore jack-up installation 100 with power production and carbon capture capability is quicker. In some examples, a converted jack-up drilling rig may be used for the offshore jack-up installation 100. The converted jack-up drilling rig is modified and the cantilever and drilling facilities are removed. A prefabricated powerplant 120 and an exhaust processing module 132 are then installed on the converted jack-up drilling rig which operates as discussed in reference to the Figures.

In some examples, there is a walkway (not shown) between the offshore jack-up installation 100 and the adjacent offshore installations 116, 118, 130. In some examples, the walkway is wide enough to receive a forklift truck. This means that e.g. palletized equipment can be conveniently moved between the offshore jack-up installation 100 and the adjacent offshore installations 116, 118, 130. This means that the main deck 112 of the offshore jack-up installation 100 can be used for extra storage space for equipment of the adjacent offshore installations 116, 118, 130.

One example will now be discussed in reference to FIGS. 4 and 5. FIGS. 4 and 5 respectively show a schematic representation of the offshore jack-up installation 100 and a close-up of the offshore jack-up installation 100.

The examples as shown in FIGS. 4 and 5 are the same as the examples discussed in reference to FIGS. 2 and 3 except that the offshore jack-up installation 100 comprises a powerplant 120 for powering and heating the exhaust processing module 132, the offshore jack-up installation 100 utilities and hotel facilities.

In some examples, the powerplant 120 may comprise one or more diesel generators with additional steam boilers. The powerplant 120 provides electrical power and heating to the exhaust processing module 132. The powerplant 120 is in fluid communication with the exhaust processing module 132. Accordingly, flue gas from exhaust from the powerplant 120 is sent to the exhaust processing module 132.

The powerplant 120 operates independently from the production platform powerplant 300. This means flue gas from both the powerplant 120 and the production platform powerplant 300 are sent to the exhaust processing module 132.

The carbon dioxide is then captured, processed and stored as previously discussed in reference to FIGS. 2 and 3.

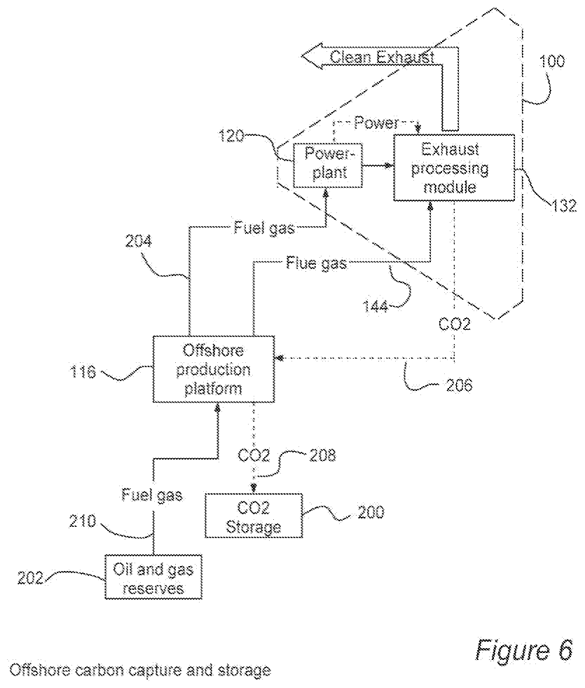

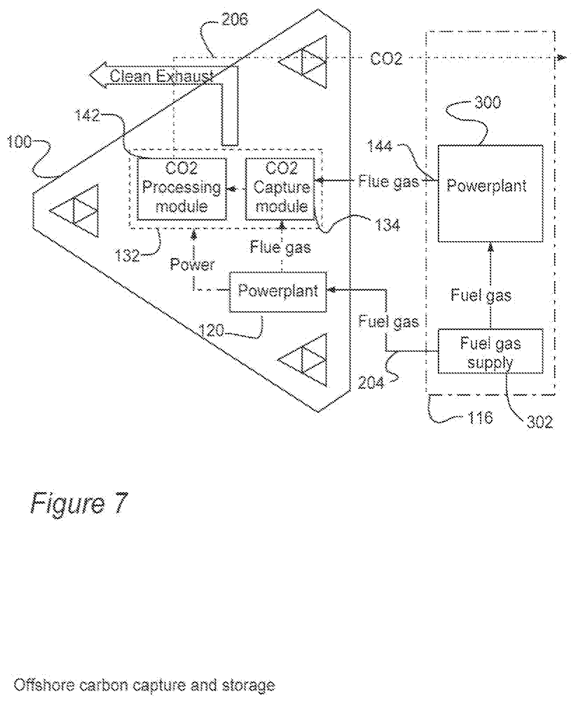

One example will now be discussed in reference to FIGS. 6 and 7. FIG. 6 shows a schematic diagram of an offshore jack-up installation 100 according to an example. FIG. 7 shows a schematic a close-up of the offshore jack-up installation 100.

The examples as shown in FIGS. 6 and 7 are the same as the examples discussed in reference to FIGS. 4 and 5 except that the offshore jack-up installation 100 comprises a gas turbine powerplant 120 for powering and heating the exhaust processing module 132.

The offshore jack-up installation 100 comprises a powerplant 120 and an exhaust processing module 132 as discussed in reference to FIG. 1. The offshore jack-up installation 100 further comprises a fuel pipe 204 connected between the offshore jack-up installation 100 and the production platform 116 for supplying fuel (e.g. fuel gas) to the powerplant 120.

The powerplant 120 may be an optimized high-efficiency co-generation powerplant incorporating waste heat recovery steam generation and highly integrated with the carbon capture system for achieving the optimum balance of fuel efficiency and carbon capture.

Advantageously, this is made possible by an integrated modular architecture of the powerplant 120 and carbon capture systems of the exhaust processing module 132 and the large deck 112 space and load-carrying capacity of the offshore jack-up platform 100. This is opposed to what may usually be accommodated on a fixed installation production platform, where such systems would have to be retrofitted and installed in-between planned shut-down of the oil and gas production facilities.

The production platform 116 sends fuel gas to the powerplant 120 on the offshore jack-up installation 100 via the fuel pipe 204. The powerplant 120 then burns the fuel gas and generates electricity and steam heating.

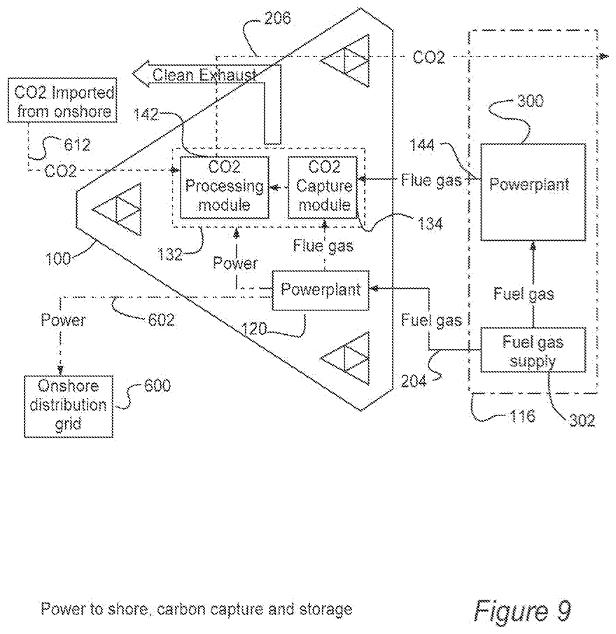

One example will now be discussed in reference to FIGS. 8 and 9. FIGS. 8 and 9 respectively show a schematic representation of the offshore jack-up installation 100 and a close-up of the offshore jack-up installation 100.

The examples as shown in FIGS. 8 and 9 are the same as the examples discussed in reference to FIGS. 8 and 9, except that the offshore jack-up installation 100 generates excess electricity which is exported onshore.

In some examples, the offshore jack-up installation 100 is connected to an onshore electricity distribution grid 600 via a subsea cable 602. Furthermore, subject to the capacity of the powerplant 120, the offshore jack-up installation 100 could also be connected by subsea power cables and send power to multiple other production platforms and drilling rigs 116, 118, 130 further away from the offshore jack-up installation 100. In this way, the offshore jack-up installation 100 can generate cleaner electricity for both onshore and offshore electricity demands.

Additionally, the offshore jack-up installation 100 in some examples is optionally arranged to receive carbon dioxide from a vessel 140 or from a separate pipeline 612 connected to an onshore source of carbon dioxide. This means that the offshore jack-up installation 100 can facilitate storage of carbon dioxide generated remote from the offshore installations. When the offshore jack-up installation 100 receives carbon dioxide from a vessel 140 or a pipeline, the carbon dioxide can be mixed with the processed carbon dioxide from the carbon dioxide processing module 142.

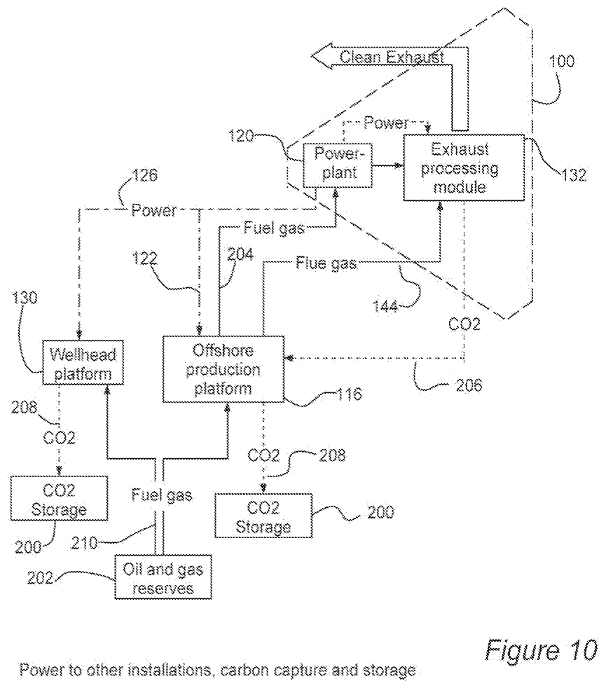

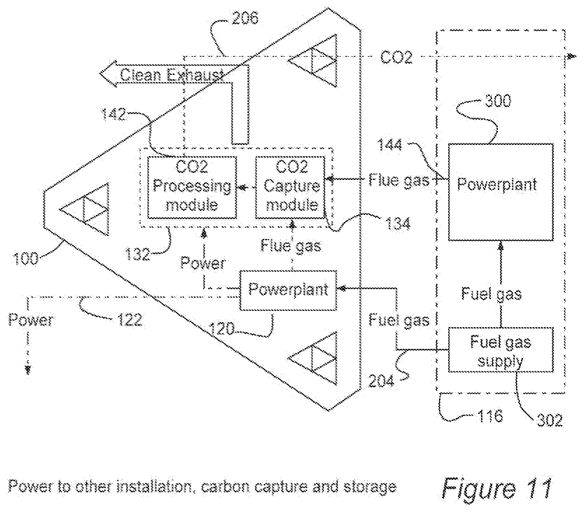

Another example will now be described in reference to FIGS. 10 and 11. FIGS. 10 and 11 respectively show a schematic diagram of an offshore jack-up installation 100 and a close-up schematic diagram according to another example.

FIGS. 10 and 11 are the same as shown in FIGS. 9 and 10 except that the offshore jack-up installation 100 supplies power to a plurality of adjacent offshore installations. FIGS. 10 and 11 optionally do not have connections to shore, but in another example, the arrangement shown in FIGS. 10 and 11 can comprise the connections to shore as discussed in reference to FIGS. 8 and 9.

Whilst FIG. 10 shows a wellhead platform 130, there can be any arrangement of other adjacent offshore installations. This can include any number of production platforms, wellhead platforms, drilling platforms or any other offshore installation.

FIG. 1 shows an example of the offshore jack-up installation 100 being electrically connected to the production platform 116 with electric cable 122. The other adjacent wellhead platform 130, and the offshore drilling rig 118 are electrically connected to the offshore jack-up installation 100 by electrical cables 126, 128. In this way, the offshore jack-up installation 100 can supply at least some or all of the electrical energy that the production platform 116 and the other adjacent offshore installations need to operate.

The wellhead platform 130 in some examples is connected to a carbon dioxide storage pocket 200 similar to the production platform 116 as discussed in reference to FIGS. 1 and 2. The capture and storage of the carbon dioxide is the same as previously discussed. As mentioned above, the wellhead platform 130 is connected to the production platform 116. The flow of carbon dioxide and/or fuel gas to and from the wellhead platform 130 is via the production platform 116. In this way, the wellhead platform 130 can provide fuel gas to the offshore jack-up installation 100 and receive carbon dioxide from the offshore jack-up installation 100 via the production platform 116. The production platform 116 controls the operation of the wellhead platform 130 and the flow of carbon dioxide thereto. Accordingly, one or more of the pipes and cables connecting the offshore jack-up installation 100 and the adjacent offshore installations 116, 130 can be shared e.g. for fuel gas, carbon dioxide and/or electricity.

Additional floating or fixed offshore installations can be connected to the offshore jack-up installation 100. For example, a drilling jack-up rig 118, a semisubmersible rig (not shown) or drilling vessel (not shown) can be electrically connected to the offshore jack-up installation 100.

In some examples, the separated carbon dioxide can be stored in a carbon dioxide storage pocket remote from the production platform 116 and the offshore jack-up installation 100. In a less preferred example, the carbon dioxide can be pumped via a subsea carbon dioxide pipe (not shown) to a submerged wellhead (not shown) for the remote carbon dioxide storage pocket (not shown). However, the production platform 116 (and/or a wellhead platform 130) is preferred as the transmission hub for any carbon dioxide being deposited underground because the infrastructure of the production platform 116 is more suitable for pumping carbon dioxide beneath the seabed 106.

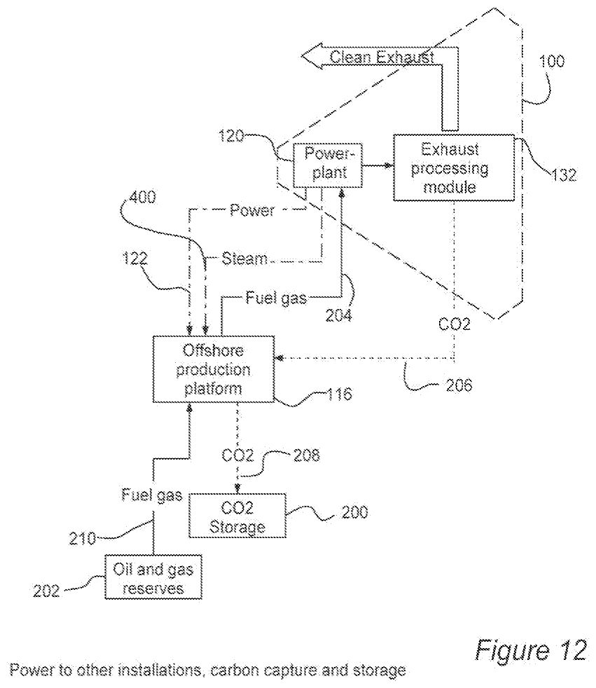

One example will now be discussed in reference to FIGS. 12 and 13. FIGS. 12 and 13 respectively show a schematic representation of the offshore jack-up installation 100 and a close-up of the offshore jack-up installation 100.

The examples as shown in FIGS. 12 and 13 are the same as the examples discussed in reference to FIGS. 10 and 11, except that the offshore jack-up installation 100 generates excess electricity and heat to power the production platform 116.

In this example, the production platform powerplant 300 has been permanently decommissioned, removed, or is offline for e.g. maintenance. Accordingly, the production platform 116 is not able to provide its own electricity or heating requirements as necessary to run the oil and gas production and export systems. Instead, the powerplant 120 on the offshore jack-up installation 100 generates both electrical power and steam for the production platform 116.

The offshore jack-up installation 100 is connected to the production platform 116 via an electrical cable 122 as previously discussed. Furthermore, a steam duct 400 is connected between the offshore jack-up installation 100 and the production platform 116.

The steam outputted from the powerplant 120 is pumped to the production platform 116 and the steam is used to heat the production equipment 402. Use of steam for heating in the oil production process on a production platform 116 is known and will not be discussed in any further detail.

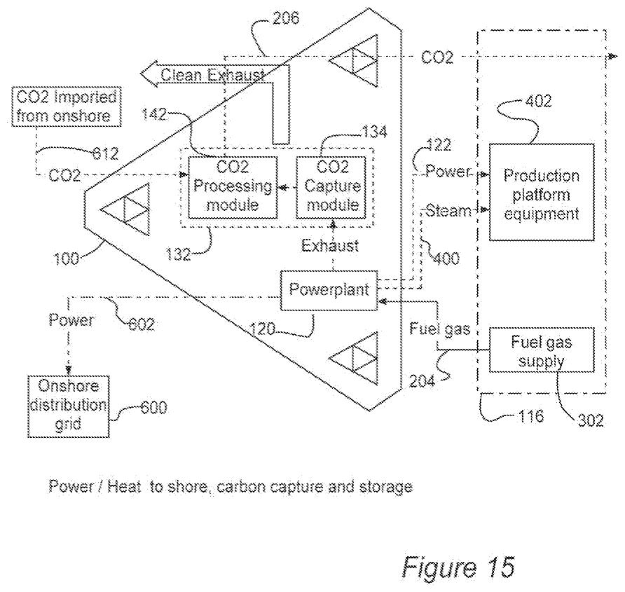

One example will now be discussed in reference to FIGS. 14 and 15. FIGS. 14 and 15 respectively show a schematic representation of the offshore jack-up installation 100 and a close-up of the offshore jack-up installation 100.

The examples as shown in FIGS. 14 and 15 are the same as the examples discussed in reference to FIGS. 12 and 13, except that the offshore jack-up installation 100 generates excess electricity which is supplied to shore and/or to other oil and gas installations in the area.

The connections to the shore are the same as discussed in reference to FIGS. 8 and 9.

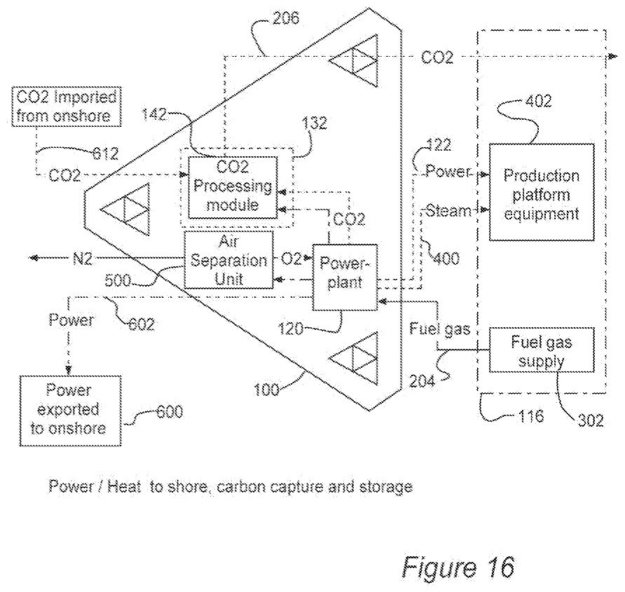

One example will now be discussed in reference to FIG. 16. FIG. 16 shows a close-up schematic of the offshore jack-up installation 100.

The example as shown in FIGS. 16 is the same as the examples discussed in reference to FIGS. 14 and 15, except that the offshore jack-up installation 100 comprises a modified exhaust processing module 132 and an air separation unit 500. In this way, the offshore jack-up installation 100 comprises an oxyfuel combustion generator.

The air separation unit 500 modifies the atmosphere in which the powerplant 120 burns the fuel gas. The air separation unit 500 removes the nitrogen from the air and concentrates the oxygen content of the air. The separated nitrogen can be vented directly to the atmosphere. In some examples, the air separation unit 500 sends pure oxygen or a gas comprising mostly of oxygen to the powerplant 120. This means that only water-steam and carbon dioxide are the by-products from the combustion of the fuel gas in the powerplant 120.

Accordingly, the exhaust comprises highly concentrated carbon dioxide once the water has been condensed from the steam. This means that the carbon dioxide capture module 134 e.g. a scrubber is not required and purification of the carbon dioxide is easier. Instead, the exhaust comprising de-watered carbon dioxide is processed by the carbon dioxide processing module 142. This is similar to the previously discussed examples. The processed carbon dioxide is then liquified and pumped for undersea storage.

The condensate water by-product may be discharged directly overboard or exported to the production platform 116 for injection into a dedicated water-injection well, e.g. for enhanced oil or gas recovery.

Whilst FIG. 16 shows electrical and carbon dioxide pipe connections to the shore, these connections are optional. The air separation unit 500 can be used without the shore connections.

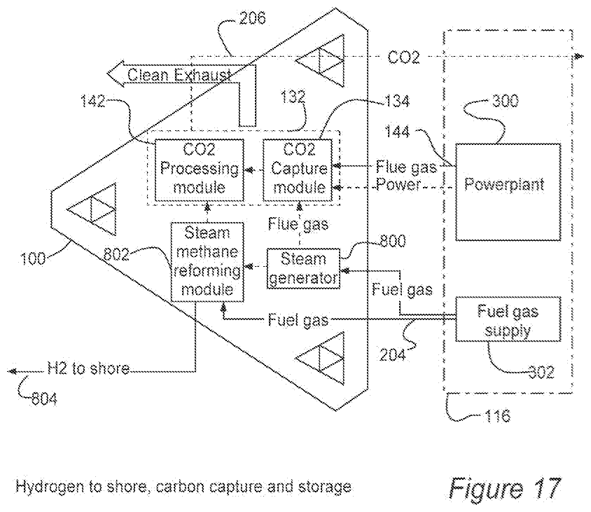

One example will now be discussed in reference to FIG. 17. FIG. 17 shows a close-up schematic of the offshore jack-up installation 100.

The example as shown in FIGS. 17 is the same as the examples discussed in reference to FIGS. 2 and 3, except that the offshore jack-up installation 100 generates hydrogen fuel, e.g. by a steam methane reforming (SMR) process.

Similar to the examples discussed in reference to FIGS. 2 and 3, the production platform powerplant 300 sends flue gas and power to the offshore jack-up installation 100.

The offshore jack-up installation 100 comprises a boiler 800 or any other suitable means for generating steam. The boiler 800 burns fuel gas received from the production platform 116 for generating the steam.

The generated steam is then sent to a steam methane reforming module 802. Accordingly, the carbon dioxide is captured before the fuel (e.g. hydrogen) is burnt. At the same time, the carbon dioxide generated from the boiler 800 is captured by the carbon dioxide capture module 134 as previously discussed.

The steam methane reforming module 802 generates hydrogen which is stored and/or pumped onshore via a pipeline or transported by an H₂ tanker vessel. Accordingly, the offshore jack-up installation 100 can create hydrogen fuel for consumption in onshore markets whilst capturing the carbon dioxide from the generated hydrogen.

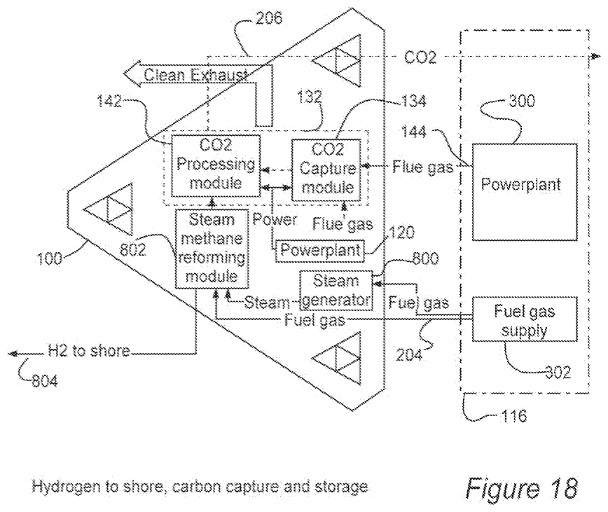

One example will now be discussed in reference to FIG. 18. FIG. 18 shows a close-up schematic of the offshore jack-up installation 100.

The example as shown in FIGS. 18 is the same as the examples discussed in reference to FIG. 17, except that the offshore jack-up installation 100 comprises a powerplant 120. In this example, the powerplant 120 provides power to the exhaust processing module 132 rather than the production platform powerplant 300. This is similar to the powerplant 120 discussed in reference to e.g. FIGS. 4 and 5.

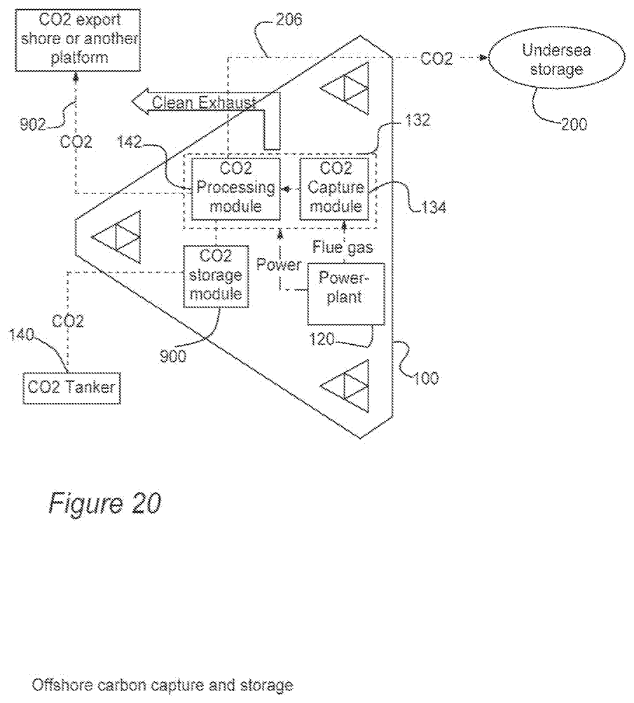

One example will now be discussed in reference to FIG. 20. FIG. 20 shows a close-up schematic of the offshore jack-up installation 100. FIG. 20 is the same as the example discussed in reference to FIGS. 4 and 5 except that the offshore jack-up installation 100 may not be connected to an adjacent production platform 116 or other offshore installation for carbon dioxide injection into an undersea storage.

Instead, the carbon dioxide processing module 142 cryogenically pumps the liquid carbon dioxide via a riser 208 for direct injection into a well under the seabed below the rig. In this way, the offshore jack-up installation 100 is directly connected to the carbon dioxide storage pocket 200 in the seabed 106.

In another example, the carbon dioxide processing module 142 cryogenically pumps the liquid carbon dioxide into a pipeline 902 for export to shore or to a platform further away from the offshore jack-up installation 100.

In another example, the carbon dioxide processing module 142 cryogenically pumps the liquid carbon dioxide into a temporary storage facility 900 onboard the rig, until the carbon dioxide may be offloaded to a carbon dioxide tanker vessel 140 for export. Similar to the example described in FIGS. 4 and 5, the powerplant 120 provides power and heat/steam to the exhaust processing module 132.

The exhaust processing module 132 can be reduced in size to provide more space on the deck 112 of the offshore jack-up installation 100. In some examples, the offshore jack-up installation 100 can be a drilling jack-up rig.

In other examples, the offshore installation 100 may be a floating rig, i.e. a drilling-semisubmersible or a drillship.

This means that the offshore drilling rig 100 may be a stand-alone/independent facility that can carry out drilling- and other well operations and also capture carbon from exhaust gases.

In another embodiment, two or more embodiments are combined. Features of one embodiment can be combined with features of other embodiments.

Embodiments of the present invention have been discussed with particular reference to the examples illustrated. However, it will be appreciated that variations and modifications may be made to the examples described within the scope of the invention.

1-17. (canceled)

18. An offshore installation comprising:
a powerplant adapted for powering an electricity distribution network of the offshore installation;
an exhaust processing module having:
an input connected to the powerplant for receiving exhaust gas comprising carbon dioxide from the powerplant,
a carbon dioxide capture module arranged to separate carbon dioxide from the exhaust gas, and
an output for outputting the separated carbon dioxide;
wherein the exhaust processing module being powered by the powerplant; and
wherein the outlet of the carbon dioxide capture module is connected to a storage facility for storing the separated carbon dioxide; and
wherein the carbon dioxide capture module comprises an absorber containing an amine solvent for binding carbon dioxide from the exhaust gas, and a regenerator for releasing the absorbed carbon dioxide by heating the amine solvent with bound carbon dioxide.

19. The offshore installation according to claim 18, wherein the carbon dioxide capture module is configured to cool the exhaust gas received from the powerplant to between 35° C. to 65° C. prior to feeding to the absorber comprising the amine solvent.

20. The offshore installation according to claim 18, wherein the carbon dioxide capture module is configured to compress the released carbon dioxide to at least 80 bar.

21. The offshore installation according to claim 20, wherein the carbon dioxide capture module is further configured to cool the released carbon dioxide, and to compress the released carbon dioxide to at least 110 bars.

22. The offshore installation according to claim 18, wherein the powerplant comprises at least one output power port arranged to output electric power to at least one other offshore installation or to an onshore electricity distribution network.

23. The offshore installation according to claim 18, wherein the carbon dioxide capture module comprises a scrubber mounted in a flue gas exhaust duct of a flue-gas exhaust system.

24. The offshore installation according to claim 18, and further comprising a steam generator in fluid communication with a steam-methane reforming module for hydrogen production.

25. The offshore installation according to claim 24, wherein the steam-methane reforming module is in fluid communication with a pipeline for supplying generated hydrogen directly to shore.

26. The offshore installation according to claim 18, wherein the powerplant and the exhaust processing module being provided on an offshore jack-up rig comprising a hull and a plurality of moveable legs engageable with the seafloor.

27. The offshore installation according to claim 18, wherein the carbon dioxide processing module is configured for cryogenically pumping the liquid carbon dioxide into the storage facility onboard the installation.

28. The offshore installation according to claim 18, and being adapted to store the outputted processed carbon dioxide in a carbon dioxide storage pocket remote from submarine oil and gas reserves.

29. A method of operating an offshore installation, the method comprising:
powering an electricity distribution network of the offshore installation by means of a powerplant;
receiving, in an exhaust processing module, exhaust gas comprising carbon dioxide from the powerplant;
separating carbon dioxide from the exhaust gas;
outputting the separated carbon dioxide for storing; and
powering the exhaust processing module by means of the powerplant,
wherein the carbon dioxide separation comprises
feeding the exhaust gas to an amine solvent binding carbon dioxide, and
heating the amine solvent for releasing the absorbed carbon dioxide.

30. The method according to claim 29, and comprising cooling the exhaust gas received from the powerplant to between 35° C. to 65° C. prior to feeding to the carbon dioxide separation.

31. The method according to claim 29, and comprising compressing the released carbon dioxide to at least 80 bar.

32. The method according to claim 31, and comprising further compressing configured to cool the released carbon dioxide to compress the released carbon dioxide to at least 110 bars.

33. The method according to claim 29, wherein the storing the separated carbon dioxide comprises storing the separated carbon dioxide in a carbon dioxide storage pocket in the seabed.
